(19) United States
(12) Patent Application Publication
(10) Pub. No.: US 2023/0023539 A1
(43) Pub. Date: Jan. 26, 2023

(54) METHOD FOR PRODUCING HYDROGEN AND OXYGEN BY MEANS OF AN ELECTROLYZER

(71) Applicant: SMS GROUP GMBH, Düsseldorf (DE)

(72) Inventors: Henry GÖRTZ, Bergisch Gladbach (DE); Frank PLATE, Düsseldorf (DE); Walter TIMMERBEUL, Wuppertal (DE); Christian GEERKENS, Jüchen (DE)

(21) Appl. No.: 17/791,655

(22) PCT Filed: Jan. 8, 2021
(86) PCT No.: PCT/EP2021/050295

§ 371 Date: Jul. 8, 2022

(30) Foreign Application Priority Data
Jan. 10, 2020 (DE) 10 2020 200 267.3
Jan. 5, 2021 (DE) 10 2021 200 029.0

(51) Int. Cl. C25B 9/65; C25B 1/04; C25B 9/23; C25B 15/02

(52) U.S. Cl. CPC C25B 9/65; C25B 1/04; C25B 9/23; C25B 15/02

(57) ABSTRACT

A method for generating hydrogen and oxygen using an electrolyzer, including at least one anode chamber having an anode and at least one cathode chamber having a cathode, wherein the at least one anode and the at least one cathode are energized by a modulated current and the generation of hydrogen and oxygen takes place within the electrolyzer using a defined pulse pattern sequence, which is formed from at least one pulse pattern.

The present invention relates to a method for producing hydrogen and oxygen by means of an electrolyzer, and to the use of a modulated current for producing hydrogen and oxygen in an electrolyzer.

In the context of the debate on climate change and the efforts for the achievement of climate neutrality, the production of hydrogen, particularly by electrolytic splitting of water, is gaining increasingly in significance.

For the production of hydrogen or for the manufacture of “eco-fuels”, electrolyzers are typically employed such as, for example, PEM electrolyzers, which are operated by means of direct current, wherein thyristor technology is applied for this purpose.

The relatively low efficiency of the methods known from the prior art is disadvantageous here.

The object of the present invention is therefore the provision of a method for producing hydrogen and oxygen, by way of which the yield of hydrogen and oxygen, in relation to the input electrical energy, can be improved.

According to the invention, the object is achieved by a method having the features of patent claim 1.

According to the method for producing hydrogen and oxygen by means of an electrolyzer, which comprises at least one anode chamber having an anode and at least one cathode chamber having a cathode, it is provided that the at least one anode and the at least one cathode are energized by means of a modulated current, and the generation of hydrogen and oxygen is executed within the electrolyzer by the application of a defined pulse pattern sequence, which is formed from at least one pulse pattern.

The pulse pattern sequence can be formed here from a single pulse pattern and/or from a combination of at least two or a plurality of different pulse patterns of a pulse pattern library.

In the same way, the present invention provides for the use of a modulated current for producing hydrogen and oxygen in an electrolyzer by the application of a defined pulse pattern sequence, which is formed from at least one pulse pattern.

According to the invention, the electrolyzer is operated using a modulated current. It has been established here that, surprisingly, the hydrogen yield in relation to the input electric power is higher than in the case of conventional DC electrolysis. By the application of a defined pulse pattern sequence, which is formed from at least one pulse pattern, the efficiency of an electrolyzer can thus be significantly improved.

A scientifically verifiable explanation for this effect has not been identified to date. At present, however, the inventors proceed from the assumption that this effect might be associated with the splitting of the “Nernst diffusion layer”.

In a further process step, for example by the Fischer-Tropsch method, hydrogen thus generated can be converted into synthetic fuels.

Further advantageous configurations of the invention are disclosed in the dependently formulated claims. The features described individually in the dependently formulated claims are mutually combinable in a technically relevant manner, and can define further configurations of the invention. Moreover, the features disclosed in the claims are clarified and described in greater detail in the description, wherein further preferred configurations of the invention are represented.

Advantageously, the modulated current is supplied by at least one pulse rectifier, the negative pole of which is electrically connected to the at least one cathode, and the positive pole is electrically connected to the at least one anode of the electrolyzer. The use of a pulse rectifier permits the option for the definition of both the magnitude and the temporal characteristic of the respective pulse pattern desired, and thus of the entire pulse pattern sequence, such that the production process can be optimally adjusted in accordance with the specified parameters.

The modulated current can advantageously be supplied by a pulse rectifier, which is configured using switched-mode power supply technology. A pulse rectifier thus configured is defined in that the grid-side AC voltage is firstly rectified and smoothed. The DC voltage thus generated, which has substantially higher frequencies, generally in the range from 5 kHz to 300 kHz, is then divided, is transformed at this high frequency, and is thereafter rectified and filtered. The superimposed voltage and current regulation is generally executed by means of pulse-width modulation or pulse-phase modulation.

As a result of the high frequency on the power transformer, the transformer is configured with a substantially lower rating, such that the energy losses are substantially smaller. Systemically, this results in a substantially higher power efficiency of the DC supply.

Structurally, the pulse rectifier can be provided with a modular structure. This results in a significantly higher availability, as the power which is to be delivered by a defective module can be assumed by another module and, in the event of the repair of a defective module, the latter can be replaced rapidly.

A further advantage is provided in that the quality of the direct current, particularly the reduced residual ripple thereof, is significantly superior with lower losses than in the case of conventional thyristor-based DC electrolysis, the repair of defective devices can be executed in a substantially more rapid and simpler manner, and existing DC current/DC voltage supply systems can be expanded by further modules retrospectively using corresponding control technology by means of which the capacity of the DC current/DC voltage supply system can be increased.

Moreover, the pulse rectifiers employed, or other appropriate voltage sources such as IGBTs (insulated gate bipolar transistors), by way of distinction from grid-connected thyristor devices, in a corresponding structure, provide the option for the preheating of the electrolyzers, particularly when the latter are interconnected with batteries and, during stationary operation at a rectifier working point lower than 100%, delivering of a correspondingly high efficiency. For an equal efficiency of the DC voltage supply, this results in an increase in the efficiency of the hydrogen production system as a whole.

In an advantageous variant of embodiment, it is provided that the at least one pulse rectifier is electrically connected to a central control unit, by means of which the production process is controlled and/or regulated. It is particularly preferably provided here that the at least one pulse pattern in the pulse pattern sequence is transmitted by the central control unit to the at least one pulse rectifier.

To this end, according to the invention, it is provided that the production process is executed by the application of a defined pulse pattern sequence, which is formed from individual pulse patterns. The pulse pattern sequence can be formed here from a single pulse pattern and/or from a combination of at least two or a plurality of identical and/or different pulse patterns of a pulse pattern library.

Customarily, the pulse pattern in the pulse pattern sequence comprises at least one cathodic pulse, which is defined by a pulse duration, and at least one pulse interval, wherein the cathodic pulse is defined by a pulse duration and the respective form thereof, for example a square-wave form.

The pulse duration of the cathodic pulse can advantageously be 200 μs to 500 ms. For technical reasons, the shortest pulse duration is limited to 200 μs. Accordingly, it is preferably provided that the shortest pulse duration is 200 μs, preferably 500 μs, more preferably 1,000 μs, further preferably 2,000 μs, and most preferably 5,000 μs.

Additionally, however, the pulse duration should not exceed a time of 500 ms. Preferably, the maximum pulse duration is therefore 500 ms, preferably 250 ms, more preferably 100 ms, further preferably 50 ms, and most preferably 10 ms.

A particularly preferred range for the pulse duration is 200 μs to 1,000 μs, very particularly preferably 200 μs to 700 μs.

The pulse interval, i.e. the time interval between two sequential cathodic pulses, can preferably be in the range of 0.01-times to 10-times the cathodic pulse, preferably in the range of 0.1-times to 5-times the cathodic pulse, more preferably in the range of 1-time to 4-times the cathodic pulse, further preferably in the range of 2-times to 3.50 times the cathodic pulse, and most preferably 5-times the cathodic pulse.

In the present case, the pulse interval can be executed at zero-current or with a holding current. In other words, temporarily, according to a first advantageous variant of embodiment, no current is fed to the electrolyzer, such that the current strength I assumes the value zero (I_{A}=0). In a further variant of embodiment, the pulse interval can be executed with a holding current. The current between two cathodic pulses is reduced here by a specific amount. This amount can advantageously be up to ⅚, preferably up to ⅘, more preferably up to ¾, further preferably up to ⅔ of the current of the preceding cathodic pulse.

The electrolyzer can be configured in the form of a membrane-based electrolyzer such as, for example, a proton exchange membrane electrolyzer, a Nafion membrane electrolyzer, a polymer electrolyte membrane electrolyzer or a proton exchange membrane fuel cell electrolyzer.

The invention, and the technical field, are described in greater detail hereinafter with reference to the figures. It should be observed that the invention is not to be limited by the exemplary embodiments illustrated. In particular, unless explicitly indicated otherwise, it is also possible for sub-aspects of the content described in the figures to be extracted and combined with other constituents and elements of knowledge from the present description and/or figures. In particular, it should be observed that the figures, and particularly the scale ratios represented, are schematic only. Identical reference numbers identify identical objects such that, optionally, comments on other figures can additionally be considered. In the figures:

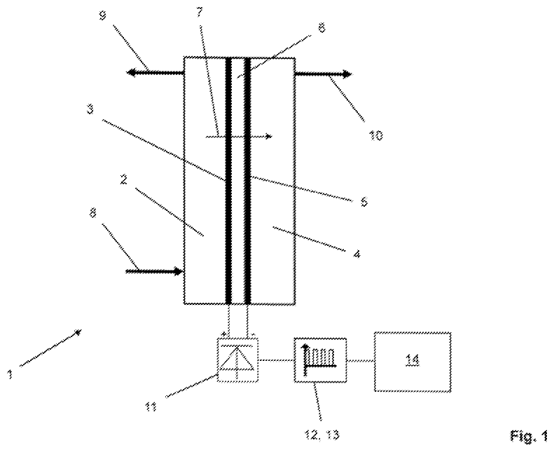

FIG. 1 shows an electrolyzer for producing hydrogen and oxygen, in a schematic representation,

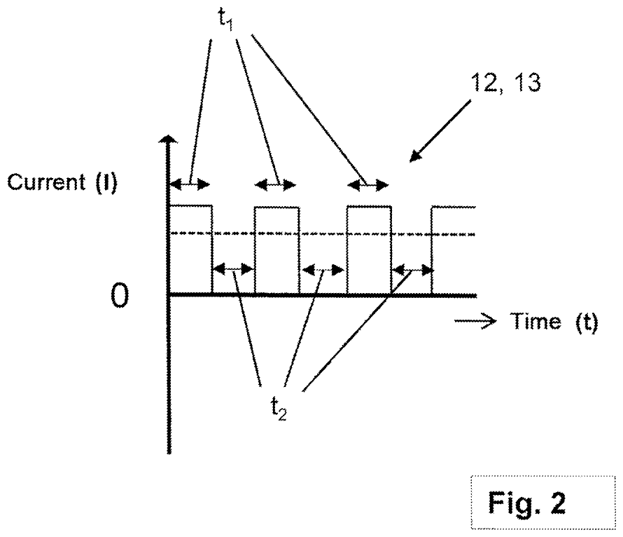

FIG. 2 shows a first variant of embodiment of a pulse pattern, which can form part of the pulse pattern sequence,

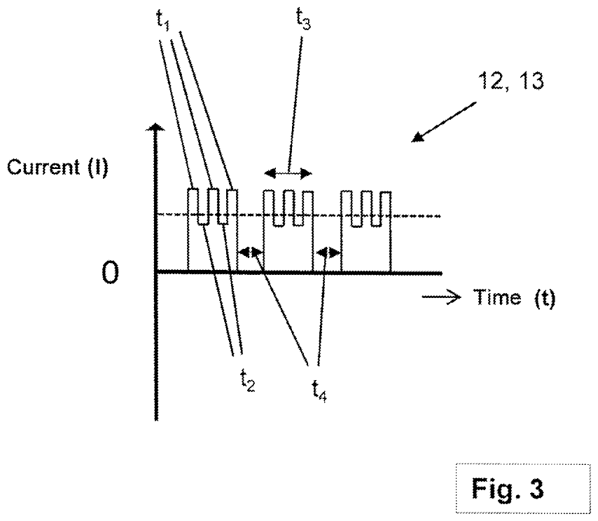

FIG. 3 shows a second variant of embodiment of a pulse pattern, which can form part of the pulse pattern sequence,

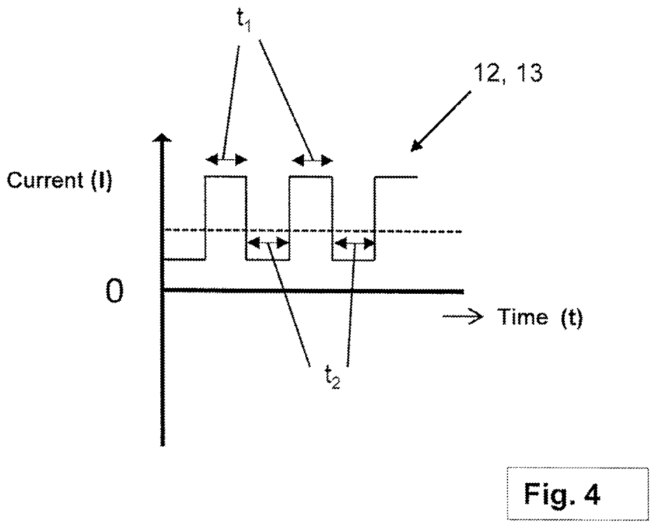

FIG. 4 shows a third variant of embodiment of a pulse pattern, which can form part of the pulse pattern sequence, and

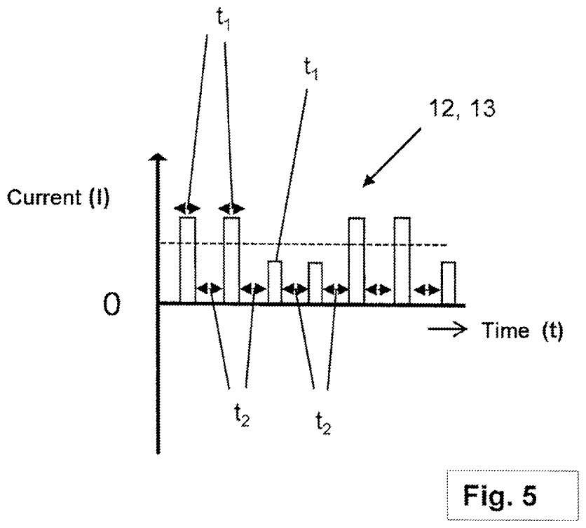

FIG. 5 shows a fourth variant of embodiment of a pulse pattern, which can form part of the pulse pattern sequence.

FIG. 1 shows a layout of an electrolyzer 1 known from the prior art for producing hydrogen and oxygen, by means of which water can be electrolytically split into the two products. The electrolyzer 1 represented here is configured in the form of a PEM electrolyzer, and comprises an anode chamber 2 having an anode 3, and a cathode chamber 4 having a cathode 5. Between the two electrodes 3, 5, a semi-permeable membrane 6 is arranged, which is permeable to protons, as symbolized by the arrow 7.

The anode chamber 2 comprises a water infeed 8 via which, preferably continuously, water or an electrolyte is admitted to the anode chamber 2, and an outlet opening 9 via which the oxygen generated can be extracted. As can further be seen from the representation according to FIG. 1, the cathode chamber 4 also comprises an outlet opening 10, via which the hydrogen generated in the electrolyzer 1 can then be extracted.

For the execution of the production process, the anode 3 and the cathode 5 are energized by means of a modulated current, which is supplied by a pulse rectifier 11, which can be configured using switched-mode power supply technology. The pulse rectifier 11 is electrically connected via its negative pole to the cathode 5, and the positive pole is electrically connected to the anode 3. By means of the modulated current, both electrodes 3, 5 can be energized, such that the process is executable by application of a defined pulse pattern sequence 12, which is formed from individual pulse patterns 13.

Advantageously, the pulse rectifier 11 is electrically connected to a central control unit 14, by means of which the respective desired pulse pattern 13 in the pulse pattern sequence 12 can be transmitted thereto.

FIGS. 2 to 5 show different variants of embodiment of pulse patterns 13 which form part of the pulse pattern sequence 12 in accordance with which the present production process can be executed.

FIG. 2 represents a variant of embodiment of a pulse pattern 12, which shows a recurrent pulse pattern 12 which is configured equivalently in terms of current magnitude (I) and time (t). The pulse pattern 12 shows a number of sequential square-wave cathodic pulses of pulse duration (t₁), each having the identical current strength (I). The individual pulses are arranged within the pulse pattern 12 mutually separated by a pulse interval (t₂), wherein t₂=t₁.

By way of distinction, the broken line in FIGS. 2 to 5 represents a temporally constant cathodic current, of the type employed in conventional direct current electrolysis (DC electrolysis).

FIG. 3 represents a variant of embodiment of a pulse pattern 12, which also shows a recurrent pulse pattern 12 which is configured equivalently in terms of current magnitude and time. The pulse pattern 12 shows a number of sequential crenelated cathodic pulses of pulse duration (t₃), which are arranged in each case mutually separated by a pulse interval (t₄), wherein t₄=½ t₁. Each of the crenelated pulses comprises three sub-pulses, each having an equal pulse duration (t₁) and an equal current strength (I). As can be seen from the pulse pattern 12, the individual sub-pulses are mutually separated by a pulse interval (t₂), which has a holding current to a value of ⅔ of the current strength of the sub-pulse. The pulse duration (t₁) and the pulse interval (t₂) are of equal length (t₂=t₁) here.

FIG. 4 represents a further pulse pattern 12, which has a recurrent pulse pattern 12 which is configured equivalently in terms of current magnitude and time. The pulse pattern 12 shows a number of sequential square-wave cathodic pulses of pulse duration (t₁), each having the identical current strength (I). The individual pulses are arranged within the pulse pattern 12 mutually separated by a pulse interval (t₂), wherein t₂=t₁. In the present case, the holding current in the pulse interval (t₂) is equal to ¼ of the current strength of the pulse.

FIG. 5 shows a further variant of embodiment of a pulse pattern 12. The pulse pattern 12 shows an alternating sequence of square-wave cathodic pulses of different current strength. The first two pulses respectively have an equal pulse duration (t₁) and the identical current strength (I). The current magnitude of the next two pulses is reduced by one half (I₂=½ I₁). All the pulses are mutually separated by a pulse interval (t₂), wherein a relationship of t₂=2 t₁ applies.

### EXAMPLES

A PEM electrolyzer was employed, as represented by the basic layout according to FIG. 1. An aqueous NaOH solution was employed as an electrolyte. The electrolyzer was operated with a current strength of 0.5 A/cm² and at a cell voltage of approximately 2 V.

In a comparative example, water was firstly broken down into oxygen and hydrogen by conventional direct current electrolysis, wherein a hydrogen volume of 50 ml/min was able to be detected.

In the example according to the invention, the electrolyzer was energized by means of a modulated current, wherein a pulse pattern sequence was employed, which consisted of the pulse pattern represented in FIG. 2. A hydrogen volume of 60 ml/min was able to be detected with an equal input electric power.

### LIST OF REFERENCE NUMBERS

1 Electrolyzer
2 Anode chamber
3 Anode
4 Cathode chamber
5 Cathode
6 Membrane
7 Arrow/direction of proton transport
8 Water infeed
9 Oxygen outlet opening
10 Hydrogen outlet opening
11 Pulse rectifier
12 Pulse pattern sequence
13 Pulse pattern
14 Control unit

1-9. (canceled)

10. A method for producing hydrogen and oxygen using an electrolyzer, comprising at least one anode chamber having an anode and at least one cathode chamber having a cathode, the method comprising the steps of: energizing the at least one anode and the at least one cathode by a modulated current; and executing the generation of hydrogen and oxygen within the electrolyzer by applying a defined pulse pattern sequence that is formed from at least one pulse pattern.

11. The method according to claim 10, including supplying the modulated current from at least one pulse rectifier that has a negative pole electrically connected to the at least one cathode and a positive pole electrically connected to the at least one anode.

12. The method according to claim 11, wherein the at least one pulse rectifier is electrically connected to a central control unit that controls and/or regulates the generation of hydrogen and oxygen.

13. The method according to claim 12, including transmitting the at least one pulse pattern in the pulse pattern sequence from the central control unit to the at least one pulse rectifier.

14. The method according to claim 10, wherein the at least one pulse pattern in the pulse pattern sequence comprises at least one cathodic pulse, which is defined by a pulse duration, and at least one pulse interval.

15. The method according to claim 14, wherein the pulse duration of the cathodic pulse is 200 μs to 500 ms.

16. The method according to claim 14, wherein a pulse interval between two sequential cathodic pulses lies in a range of 0.01-times to 10-times the cathodic pulse.

17. The method according to claim 10, wherein the electrolyzer is a membrane-based electrolyzer.

18. A method for generating hydrogen and oxygen in an electrolyzer using a modulated current by applying a defined pulse pattern sequence that is formed from at least one pulse pattern.
